(19) United States
(12) Patent Application Publication
(10) Pub. No.: US 2005/0197826 A1
(43) Pub. Date: Sep. 8, 2005

(54) Embedded translation document method and system

(76) Inventor: Yoni M. Neeman, Herzlia (IL)

Correspondence Address: DICKSTEIN SHAPIRO MORIN & OSHINSKY LLP, 2101 L Street, NW, Washington, DC, 20037, US

(21) Appl. No.: 11/068,839

(22) Filed: Mar. 2, 2005

Related U.S. Application Data
(60) Provisional application No. 60/548,889, filed on Mar. 2, 2004.

(51) Int. Cl. G06F 17/28

(52) U.S. Cl. 704/2

(57) ABSTRACT

A model for a digital, computer readable document that includes a hidden layer of embedded translations for the words and phrases that occur in the overt text of the document is disclosed. A hidden layer contains translations of these words and phrases from the original or overt language of the document to any given language, or to several given languages. Embedded translations that are in the hidden layer become overt when a user actively requests to see them, using an operating means. Translations are inserted automatically, by computer program, or manually by human translator. The format of the file will present the original text by default and the translations by specific user activation. Embedded translations are also usable by search engines, enabling the indexing of content of the document in the language(s) that appear in the embedded translation layer, in addition to the original language.

### CROSS-REFERENCE TO RELATED APPLICATION

This application claims the benefit of U.S. provisional application serial No. 60/548,889, filed Mar. 2, 2004.

### FIELD OF THE INVENTION

The invention relates to a system and method for computerized language translation.

### BACKGROUND OF THE INVENTION

Computerized translation from one language to another is a growing field of technological development. However, engines offering a full-page machine translation, such as Babelfish (http://babelfish.altavista.com/) and Systran (http://www.systransoft.com/), still cannot produce accurate and reliable results. Semantic ambiguity is one barrier to machine translation, morphological ambiguity is another barrier, and further barriers are the result of the special nature and complexity of human languages, and the dependency of language understanding on real world knowledge. There is a large amount of evidence that filly-automatic, high-quality machine translation is impossible, beginning with Y. Bar Hillel, “The Present Status of Automatic Translation of Languages,” Advances in Computers VI, pp. 91-163 (1960), showing that high quality machine translation was not attainable in principle and more recently, for example, Alan K. Melby, “Why Can't a Computer Translate More Like a Person?” Translation, Theory and Technology, 1995 Barker Lecture (http://www.ttt.org/theory/barker.html) (1995).

Some results produced by machine translation can have meanings that are very far from the original language of the,text. Often, a user that looks at an entire page that was translated to another language is not aware of the lack of consistency with the original text, or cannot understand the meaning of the translated text at all, as shown in FIG. 1. FIG. 1 illustrates a screenshot of a segment of text translated by Babelfish, having a meaning that is obscured by the translation engine. Thus, due to inherent ambiguities found in any given language, machine-translated documents in only the target language are often misleading or unintelligible.

Dictionary look-up products such as “Babylon” and Quickdic (offered at http://www.forest.impress.co.jp/article/1999/04/08/quickdic.html) and Dr. Mouse (offered at http://www.jp.joshin.jp/products/justsystem/drmouse/), as well as server-based programs such as POPjisyo (http://www.popjisyo.com/) and Todd David Rudick's Rikai (http://www.rikai.com/) are not translation engines, but offer monolingual or bilingual dictionary definitions, similarly to a printed dictionary, but using a computer interface and employing lexicons that are in full or partially downloaded to the user's client. Dictionary look-up is very different from translation in many ways, including the inability to provide different translations of the same input word in different contexts (context-sensitivity) and the inability to translate inflected forms, not just basic forms, into corresponding inflected forms in target language.

While there have been some attempts at word and phrase recognition, such as disclosed in U.S. Pat. No. 6,393,433 to Rubin et al., or context indicators, such as disclosed in U.S. Pat. Nos. 6,341,306 and 6,519,631 to Rosenschein et al., they offer only some of the features that would be desirable in a language translation system. In an increasingly diverse global society where -advances in technology are reaching a broader variety of users and information is being shared among them via intranets and the internet, language barriers continue to be an obstacle. Thus, computerized language translation in a search system in a server that produces a separate file containing a context-sensitive translation, without dispensing of the original text, is desirable. Such a system would allow a user to have context-sensitive translations of portions of search results from the search engine, while still being able to see the original text, thereby obtaining a better idea of what information is available from various links even when linked and described in a foreign language, without having to load the translation software onto the user's computer.

### BRIEF SUMMARY OF THE INVENTION

The present invention is a system and method that supports digital, computer readable information that includes a hidden layer of embedded translations for the words and phrases that occur in the overt text of the information. A hidden layer contains translations of these words and phrases from the original or overt language of the document into any given language, or to several given languages. Embedded translations that are in the hidden layer become overt when a user actively requests to see them, per given word or phrase, using a mouse action, a key combination, a touch on the screen, or any other operating means. Translations are inserted automatically, by computer program, or manually by human translator. The format of the file is such that will present the original text by default and the translations by specific user activation. Embedded translations are also usable by search engines, enabling indexing of the content of the document in the language(s) that appear in the embedded translation layer, in addition to the original language.

### BRIEF DESCRIPTION OF THE DRAWINGS

FIG. 1 is a screen shot of machine translation using a method of the prior art;

FIG. 2 is a diagram demonstrating the method of the present invention;

FIG. 3 is an exemplary screen shot of an embodiment of the present invention having HTML text in a Window;

FIG. 4A is a segment of an HTML file;

FIG. 4B is a translation of the segment of FIG. 4A;

FIG. 5 is a flow chart of an exemplary process of the present invention;

FIG. 6 is a segment of an exemplary HTML tooltip file according to the present invention;

FIG. 7 is a segment of an exemplary HTML Java script file according to the present invention;

FIG. 8 is a segment of an exemplary RTF file according to the present invention; and

FIG. 9 is an exemplary screen shot of an RTF file in Microsoft Word according to the present invention.

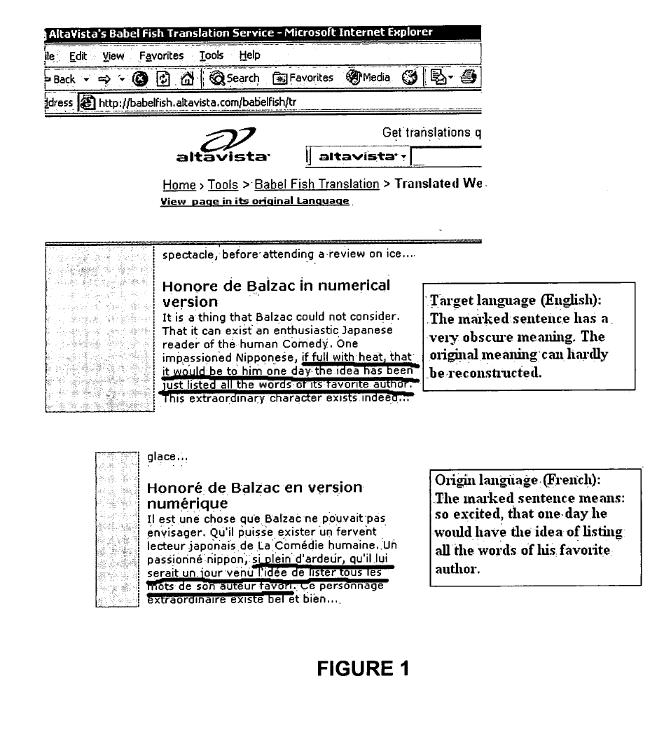

### DETAILED DESCRIPTION OF THE INVENTION

The present Embedded Translation Document (ETD) invention relates to the creation of digital information, including digital documents, such as web pages or word processor documents, which contain a sub-layer of translation. Each word, or in some cases a phrase, in the visible layer of this document has, associated to it, its appropriate translation in this hidden layer. In order to see this translation, the reader of the document has an operating means, or selector, at his or her disposal, responsive to the reader's selection of a portion of the visible text layer, for exposing a portion of the invisible layer over the corresponding portion of the visible layer, including, but not limited to, hovering, clicking, or double-clicking a mouse over the said visible portion, touching it with an electronic pen, touching it with a finger using a touch-sensitive display screen, or pointing to it using a joystick.

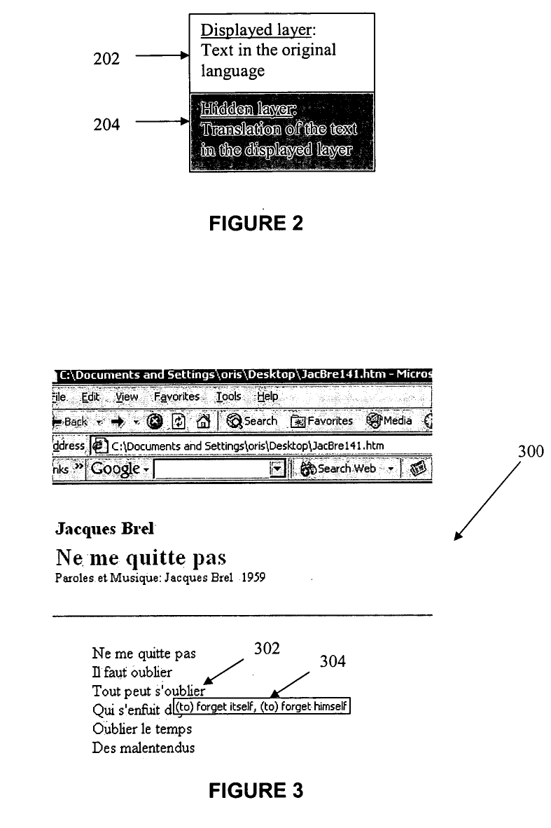

ETDs can be created automatically by a computer program, or by manual editing (to be discussed below). An ETD includes the translation of the words that occur in it from the original language to any other target language or languages. When the user requests the translation using one of the above described operation means, the translation is displayed, e.g. in a small pop-up window, at the bottom of the screen, or on any other location and through any known or conventionally used means of display (e.g., CRT display, LCD, TV, etc.). It should be noted that the present invention can be implemented using an audio system that provides audio delivery of the translated portions either alone or in conjunction with the visual display. The ETD model is illustrated in FIG. 2, which is a diagram demonstrating a displayed layer 202 and a hidden layer 204. The translation of the displayed layer, i.e., the hidden layer 204, is shown only when the user requests it; otherwise the original document is shown without the translations. The original text of the displayed layer 202 may be any text document, such as HTML, DOC, PDF, or other document file type.

Because the translations are already present in the page as an underlying layer 204, no additional special-purpose translation program need be installed and invoked to display the translation; the display is effectuated using either existing functionality such as the tooltip function of HTML files, or a script in the data file itself. Also, no Internet connection is needed and the translation is included in the page when it is sent, for example, by e-mail. Unlike clickable dictionaries, such as “Babylon” (http://www.babylon.com/), no client application is necessarily required for invoking translations of the words that appear in the original text of ETDs. However, it is contemplated that other embodiments of the invention are envisioned whereby the model can be implemented using a client application.

The translations appear in the ETDs in a manner that makes them available for the user only upon the user's request; unless the user activates the translations, they remain hidden from view. Only when the user activates the embedded translation per given word through the operating means is the translation brought up and displayed on the means of display, as shown in FIG. 3. FIG. 3 illustrates a screen shot 300 of an embodiment of the present invention having HTML text in a Window with French 302 as the displayed text and English 304 as the hidden translated language. In FIG. 3, the hidden translated language 304 floats over the displayed text 302 in the original French language. This model 300 enables the user to read the page in its original language, and receive an immediate translation for any word that appears in the page. Unlike automatic machine translation services (MT), which attempt to translate a whole page from its original language to another language, in the ETD model, the original language of the text remains intact, and the translation is added on a per-word or per-phrase basis, only as a hidden layer. For a person who has some knowledge of the original language of the text, even if it is very limited, this product and method provides a more credible manner to filly understand the text of a document.

ETDs give the user access to both the original and target language; thus in situations where the reader has some knowledge of the original language, he or she may use this knowledge to understand a major part of the text, and consult the embedded translations only when needed. An additional benefit of ETDs is that they are not confined to supplying a single target language translation per given source-language word. In other words, a certain amount of ambiguity may be retained in the translation. For example, consider a document with original text in English, where the following sentence appears: “the inspectors are looking for arms.” In an ETD document with a Spanish translation layer, the word “arms” will be translated as “brazos, armas.” Thus the reader of the sentence will be able to deduce that in this context, “armas” is the appropriate translation, where a machine translated document, by contrast, is very likely to inappropriately choose the wrong translation, “brazos” in this case, i.e., arms in the body-part sense, and leave the reader with incomprehensible Spanish translation text.

As another illustration of how an ETD considers context, the words “world wide web” is known as a phrase in English. In an ETD document with a French translation layer, “world wide web” may be translated as “internet.” Thus, the reader will be able to recognize that the three words, in context, are typically grouped in a phrase with a meaning “internet,” whereas a conventional machine translation, by contrast, is very likely to inappropriately translate each word separately, from “world” to “monde,” i.e., world in the earth sense, “wide” to “au loin” or “gross,” i.e., wide in the thick sense, and “web” to “enchainement, i.e., web in the spider sense.

Another way in which ETD considers context is synthesis of translated forms. An English plural noun such as “books” can be translated to the equivalent Spanish plural form “libros,” but only if the context of the word “books” shows the word to be a noun in plural form, and not a verb in third person present inflection, such as in the context “he books.”

The method of creating an ETD may be implemented automatically by a computer program, or by manual editing.

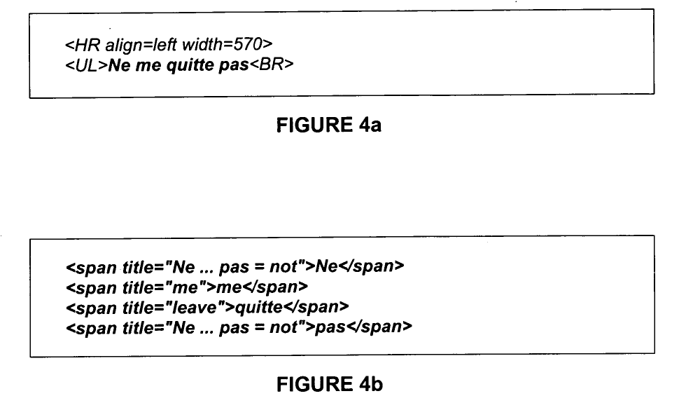

A computer program for creating ETDs contains the following processes (the exemplary embodiment is described in the HTML file format, as a private case of a digital file format that contains text):
1. Receive an input file in the original language.
2. Parse the input file, and identify the strings in it that are words, and not format tags, directives, or numbers. For example, FIG. 4A is a segment of an HTML file which reads <HR align=left width=570> and <UL>Ne me quitte pas<BR>. In FIG. 4A, “<HR align=left width=570>” sets the layout of the text. Only the words “Ne me quitte pas” in French, which mean “Do not leave me” in English, need to be translated.
3. Send each word to a bilingual dictionary and receive a translation for it. For example, the HTML file of FIG. 4a sends “Ne” to a bilingual dictionary which associates it with “ne . . . pas” and translates it to “not”; “me,” translates directly to “me”; “quitte” translates to “leave”; and associates “pas” with “ne . . . pas” and translates it to “not.”
4. As shown in FIG. 4b, insert in the HTML file a target language translation of a word or phrase next to this word or phrase, using a format that will make this translation invisible in the default display of this page, but associated to the original word and available for display in case it is triggered by the user.
5. Save the page with its underlying invisible translations. (Not shown).

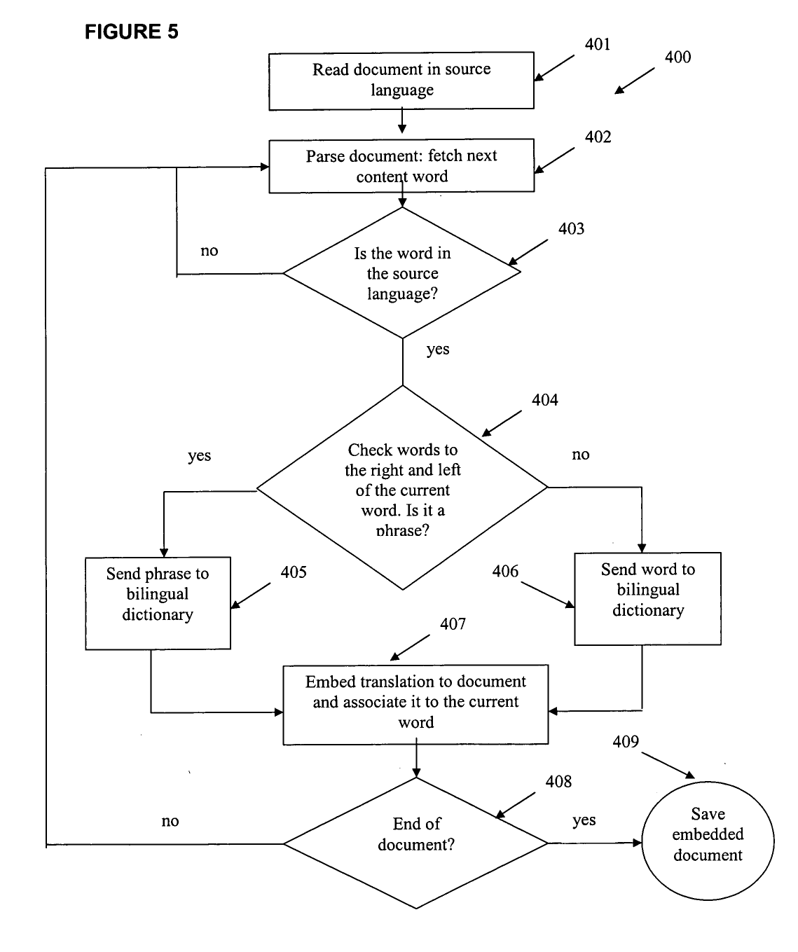

While the above description is one example of how an ETD is created using the HTML file format, the following flow chart of an exemplary process for creating an ETD, generally, is illustrated in FIG. 5. In a reading step 401, the system 400 reads the document in its source language. The document is then parsed in parsing step 402. In parsing step 402, each content word of the document is individually fetched. In step 403, the system 400 determines whether the fetched word is in the source language. If it is found not to be in the source language, the system 400 returns to the parsing step 402 and fetches the next content word. If it is found to be in the source language, the system 400 checks the words to the left and right of the current word in context-checking step 404. If the current word and one or both of the words to the left or right of the current word make up a phrase, the system 400 sends them together to a bilingual dictionary for translation by means of a phrase-translation step 405. If the current word is not a part of a phrase, the system 400 sends it to a bilingual dictionary for translation by means of a word-translation step 406. Once one of either the phrase-translation step 405 or the word-translation step 406 is completed, the system 400 advances to an embedding step 407. In embedding step 407, the translated word or phrase is embedded in an embedded document and associates it to the current word in the source document. The finishing step 408 determines whether the current word is the last word in the source document. If not, it returns to the parsing step 402 and repeats the steps from the parsing step 402. If the current word is the last word in the source document, the system undergoes a saving step 409 in which the embedded document is saved.

A manual process of creating an ETD follows the same steps as described in FIG. 5, using a human translation instead of a computer dictionary/translation program, and a text editing program to insert the translation instead of automatic insertion. Any combination of the above can also be employed. For example, a computer translation combined with manual text editing can be performed, or human translation followed by automated insertion.

It is understood that other processes for creating ETD's may be utilized without detracting from the scope of the present invention. ETDs may be manifested in any format, including HTML documents, word processor documents and PDF files. The ETD model 200 is not confined to a specific file format, but rather, it applies to any file that is used for displaying text, where an underlying layer is enabled. Thus the ETD model is applicable, in addition to HTML and its extensions, to any conventionally known word processor formats such as Microsoft Word Doc, Word Perfect, AppleWorks, RTF, PDF documents, etc. The ETD manifestation can be viewed by respective conventional viewers for these formats, including, but not limited to, Microsoft Internet Explorer and Netscape Mozilla for HTML files, Microsoft Word for RTF files, and Adobe Acrobat Reader for PDF files.

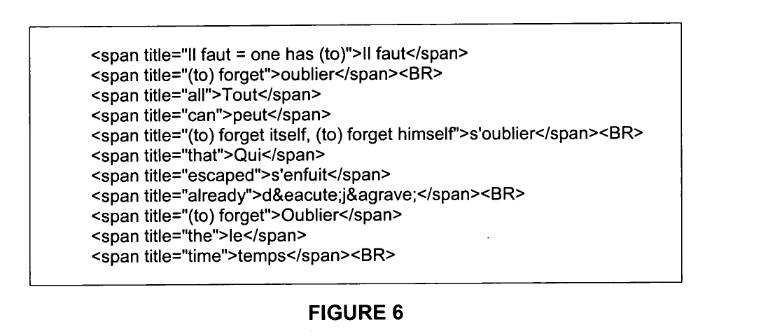

Three examples of applications are shown in FIGS. 6-9. FIG. 6 shows an exemplary application using the built-in HTML tooltip-like feature, a “tide” property of a “span” tag in this case. It features a sample of HTML document source data that contains underlying translation using the HTML tooltip. In this example, when the mouse is hovered over the displayed French word “s'oublier”, the “span” tag will cause the English translation of this word to pop up, containing the morphological translation of this word, “(to) forget itself, (to) forget himself.”

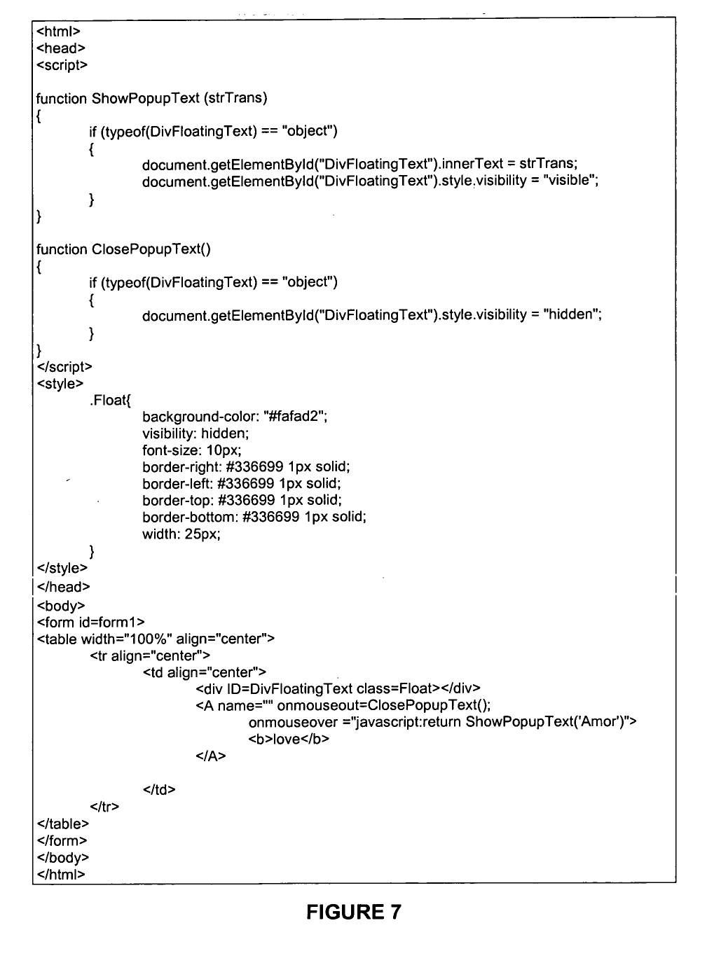

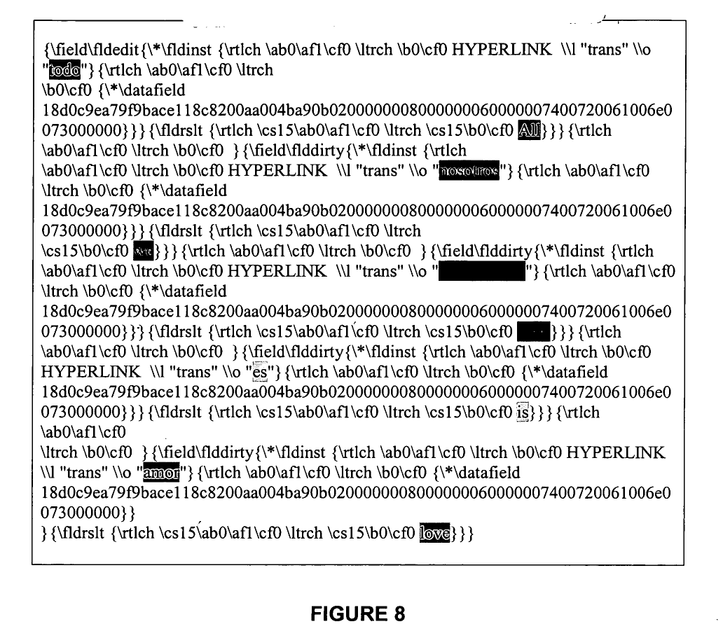

FIG. 7 shows another exemplary manifestation, again in HTML format, but using a Java script function. It features a sample of HTML document source data that contains underlying translation using a pop-up java script function. Rather than using the HTML “span” tag, this example shows how Java Script functions, in this case “ShowPopupText” and “ClosePopupText,” are used in order to create the page. The source English text “love” is shown by default, and the pop-up translation to Spanish, “amor,” is shown when the readers hover the mouse over the English word, thereby triggering the “ShowPopupText” function.

FIG. 8 shows an exemplary manifestation on RTF format, using psuedo-hyperlink tags. It features a sample of RTF document source data that contains an underlying translation using the existing hyperlink functionality of RTF files. The translations are entered as pseudo-hyperlinks, liking to a dummy bookmark, but displaying the translation as a hyperlink screen-tip. The translation will display when the mouse is hovered over the original language words. The words are shaded for illustrative purposes.

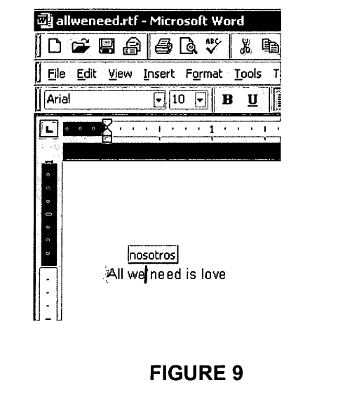

FIG. 9 is an exemplary screenshot of an RTF file as demonstrated in FIG. 8 when viewed by Microsoft Word. It illustrates how the same manifestation will show on the Microsoft Word application. In FIG. 9, the mouse is hovering over the word “we” with “nosotros” as the translation.

The ETD model can have many different implementations. It can be used for a word-to-word translation, allowing the user to bring up translations of words that are included in the document, as discussed above. It can also be used for translation of phrases, and include advanced morphological capabilities such as morphological analysis for the original language (e.g., phrase recognition), and morphological generation for the target language (e.g., grammatical forms). For example, a verb in the past tense of the original language can be translated to a verb in the past tense of the target language.

The ETD model can also be applied in cross language search applications. A document in French language that contains a hidden layer with translation to English can be searched using English key words. For example, an English-speaking user may search the Google search engine (http://www.google.com/) for information that only appears in French documents. If these documents contain hidden translation to English, the user can get the information using English key words. The results page created dynamically by Google may also be processed for ETD, so the user can hover the mouse on the results and find out if they are relevant for him or her.

The above description and drawings are only to be considered illustrative of exemplary embodiments which achieve the features and advantages of the invention. Modification of, and substitutions to, specific process conditions and structures can be made without departing from the spirit and scope of the invention. Accordingly, the invention is not to be considered as being limited by the foregoing description and drawings, but is only limited by the scope of the appended claims.

1. A structured data file comprising:
a visible layer containing text of a first language;
an invisible layer underlying said visible layer and containing context-sensitive translations of portions of said first language in a second language or languages; and
an invisible tag linking portions of said visible layer to corresponding portions of said invisible layer, enabling exposure of a portion of said invisible layer, triggered by a user of the file, wherein a translation of said visible text is visible when said visible layer is displayed.

2. The structured data file of claim 1, wherein said data file is server-based.

3. The structured data file of claim 1, wherein at least some portions of said first language contain phrases of more than one word.

4. The structured data file of claim 3, wherein said portion of said invisible layer is exposed directly over a corresponding portion of said visible layer.

5. The structured data file of claim 3, wherein said portion of said invisible layer is exposed at a location which does not cover a corresponding portion of said visible layer.

6. The structured data file of claim 1, wherein said structured data file is linked to at least a second structured data file.

7. The structured data file of claim 6, wherein said structured data file is a search engine results listing and said second structured data file is one of a plurality of results listed.

8. A data structure system comprising:
a processor;
means for displaying a visible text layer in a first language;
an invisible text layer containing a translation of said visible text layer in a second language, wherein said translation is a morphological analysis of said first language;
tagging means for linking said invisible text layer to said visible text layer, wherein said invisible text layer has a portion-for-portion correspondence with said visible text layer; and
means responsible to user selection of a portion of said visible text layer for displaying a corresponding portion of said invisible text layer.

9. The data structure system of claim 8, wherein said system is server-based.

10. The data structure system of claim 8, wherein said system is a search engine.

11. The data structure system of claim 8, wherein said portion of said visible text layer contains at least two words.

12. A translation method using a processor comprising the steps of:
receiving a data file including text written in a first language;
translating through a processor in a server said text, portion by portion, to a second language or languages, wherein each portion contains at least one word;
inserting said translations into said data file; and
providing a plurality of tags linking portions of text from a visible layer to corresponding translations on said invisible layer.

13. A manual translation method comprising the steps of:
receiving a data file including text written in a first language;
translating said text, portion by portion, to a second language,
wherein each portion contains at least one word;
inserting a series of translations into said data file; and
providing a plurality of tags linking portions of text from a visible layer to corresponding translations on said invisible layer.

14. The method of claim 13, wherein said step of translating said text includes morphologically analyzing each portion.

15. The method of claim 13, wherein said step of translating said text includes morphologically generating each translation.

16. A translation system comprising:
a server providing translation between at least a first and second languages;
a processor in communication with said server;
a data structure file comprising:
a visible layer containing a first text of said first language;
an invisible layer underlying said visible layer and containing translations of portions of said first text in said second language or languages;
a tag linking portions of said visible layer to portions of said invisible layer;
a selector for selection by a user of a portion of text on said visible layer of text and following a tag from said portion of text to locate a corresponding portion of said invisible layer; and
a display device for displaying said portion of said invisible layer of text on said display responsive to said selection of said portion of text.

17. A search engine comprising:
a data structure file comprising:
a visible layer containing a first text of said first language;
an invisible layer underlying said visible layer and containing translations of portions of said first text in said second language or languages; and
a tag linking portions of said visible layer to portions of said invisible layer;
a selector for selection by a user of a portion of text on said visible layer of text and following a tag from said portion of text to locate a corresponding portion of said invisible layer; and
a display device for displaying said portion of said invisible layer of text on said display responsive to said selection of said portion of text.

18. The search engine of claim 17, wherein said translations are morphologically generated.

19. A personal computer having a search browser comprising:
a processor;
a data structure file comprising:
a visible layer containing a visible search result of a first language;
an invisible layer underlying said visible search result and containing translations of portions of said visible search result in said second language; and
a tag lining portions of said visible search result to portions of said invisible layer;
an operating means for selecting a portion of text on said visible search result;
a display device for displaying a portion of said invisible layer of text that is linked to said selected portion of said visible search result.
